(19) United States
(12) Patent Application Publication
(10) Pub. No.: US 2006/0168273 A1
(43) Pub. Date: Jul. 27, 2006

(54) Mechanism for removing data frames or packets from data communication links

(76) Inventor: Ofir Michael, Rishon-LeZion (IL)

Correspondence Address: Martin Moynihan;PRTSI, Inc., P.O. Box 16446, Arlington, VA, 22215, US

(21) Appl. No.: 11/264,151

(22) Filed: Nov. 2, 2005

Related U.S. Application Data
(60) Provisional application No. 60/522,752, filed on Nov. 3, 2004.

(51) Int. Cl. G06F 15/16

(52) U.S. Cl. 709/230

(57) ABSTRACT

An apparatus for non-intrusive protection against unwanted data segments, transmitted through a data communication link, the apparatus comprising: a detector, configured for detecting a data segment in the data communication link, and an invalidator, associated with the detector, configured for invalidating the data segment upon the data segment being deemed unwanted.

### RELATED APPLICATIONS

The present application claims priority from U.S. Provisional Patent Application No. 60/522,752, filed on Nov. 3, 2004, the contents of which are hereby incorporated by reference.

### FIELD AND BACKGROUND OF THE INVENTION

The present invention relates generally to the field of data communication networks. More particularly but not exclusively, the present invention relates to protection against hostile or other unwanted data transferred on data communication networks.

Modern enterprises are reliant on their IT to perform their day-to-day operations. IT systems are continuously used to communicate with partners, providers, customers and other public and private data networks, such as the Internet. Businesses have grown to be dependent on those communication channels.

Unfortunately, these communication channels have been exploited by Malicious Content (Malware), which has become a common problem for today's enterprises. Malicious Content is classified into several categories: Computer viruses—malicious computer programs that replicate themselves, Worms—computer programs which quickly spread through a computer network and clog up the network, Spyware—deceptive software that installs itself on a computer and allows an outsider to harvest private information, and Trojan horses—programs that appear to have some useful or benign purpose but really mask some hidden malicious code.

Such malware directly exploits expensive IT resources and exposes internal confidential information to attackers.

An enterprise internal computer network usually comprises of tens to hundreds of thousands interconnected computers. The internal network is usually connected to an external network (or networks), such as the Internet, to carry out communications with peers outside the organization. Most of the internal computers continuously communicate with peers inside and outside the enterprise at the same time, to perform the day-to-day activities. The enterprise's workers, who use those computers, access different channels to transfer information. For example, workers use email to exchange messages and files with peers inside and outside the organization.

Several widely popular tools are currently used to fight malware. Two of the most dominant known in the art tools are Firewalls, and Intrusion detection/prevention systems (IDS/IPS). Recent surveys suggest that more than 95% of modern enterprises use firewalls software, while more than 60% of business enterprises deploy IDS/IPS systems. This emphasizes the significance of the malware problem, faced by enterprises today.

Data communication networks are comprised mostly of computers, servers, and any other communication network nodes (generally referred to hereby as nodes). These nodes are connected together by various types of networking equipment and communication links.

In most common data communication networking scenarios, a communication link is setup to connect two nodes. A transmitter sends data segment in a form of a frame or a packet (generally referred hereby as data segment) on this communication link. Every packet or frame sent from the transmitting node is exclusively received and processed at the receiving node. For this reason, frames, packets or data segments cannot be removed from the communication link.

A data communication network enables data communication between various entities such as computing devices (servers, workstations desktop computers and other hosts), storage devices (disks, tapes), and output devices (such as printers). Data communication between any two such entities is commonly created by placing a communication node in each entity and connecting these nodes by a communication link. At these communication nodes the most common data communication model used is the OSI (Open Systems Interconnection) seven layers model.

Reference is now made to FIG. 1 which is a block diagram illustrating the seven layers OSI model.

The OSI model defines a framework for implementing networking protocols in seven layers. In this model, the transmitter sends the data segments—frames or packets from one layer to the next until each frame/packet reaches the lowest layer. Each lower layer adds an additional control information section to the data segment received from the layer above. In the lowest layer the frames or packets are transmitted to the receiver via the physical communication link connecting the transmitter to the receiver. At the receiver side the reverse process occurs. Frames or packets received from the transmitter through the communication link are moved up from layer to layer until reaching their destination.

For example, Layer One of the OSI model is the physical layer. It conveys the bit-stream, which is a form of electrical pulses, of various forms through the network at the electrical or optical level. Layer One also provides the hardware for sending and receiving the data on the communication link, including the definition of the cables, connectors, cards and other physical aspects. In the receiver side, Layer One generates the bit stream out of the electrical signals from the communication link hardware.

Above Layer One, there is Layer Two—the Data Link Layer. At the transmitter side—Layer Two disassembles the data frame or data packet into a bit stream and sends it to the lower layer—Layer One. At the transmitter side—Layer Two also adds various error control sequences such as CRC, checksum or parity bits. At the receiver side—Layer Two creates data packets or data frames, which are encoded out of the bits-stream received from Layer One. Layer Two furnishes transmission protocol knowledge and management and handles errors which occurred in the lower layer—Layer One. Layer Two (and Three) also performs a validity check on the assembled frame or packet which it receives from Layer One. In case the received frame or packet contains errors, this specific frame or packet is discarded and ceases to exist anywhere.

In data communication networks, each data segment, in a form of frame or a packet, is transmitted from one communication node to another communication node via the communication link between the nodes. Each transmitted frame or packet reaches the receiver and is then processed by the receiver node.

Reference is now made to FIG. 2a which illustrates a prior art scenario for deleting or removing frames or packets from a communication link. Most Firewalls or Intrusion Prevention Systems/Detection (IPS/IDS) common today implement this prior art scenario.

A transmitter 21 transmits the frames or packets 23 (numbered #1 through #5), via a communication link 22, to a receiver 24. In order to delete an unwanted frame or packet—such as the ones marked as #1 and #3, in common art practices, an intermediate node is inserted, for example—a Firewall 26 or an Intrusion Detection System (IDS). In this prior art scenario the transmitter 25 transmits the frames or packets 29, destined for the receiver 27, through this intermediate node 26. The intermediate node 26 (the Firewall or the IDS) processes the frames and deletes or discards the unwanted or hostile frame or packet 28. Allowed frames or packets 20 continue on the communication link to the original destination 27, unharmed.

For example, Shwed et al U.S. Pat. No. 5,835,726, entitled “System for securing the flow of and selectively modifying packets in a computer network” discloses a Firewall system for controlling the inbound and outbound data packet flow in a private computer network. With this Shwed et al patent, Firewalls are positioned in the computer network such that all traffic to and from the private computer network, to be protected, is forced to pass through the Firewall. Thus packets are filtered as they flow into and out of the network, passing through the Firewall.

With prior art, in order to filter or remove unwanted or hostile frames or packets destined to a particular end node, an intermediate node has to be inserted between the existing nodes, creating a new set of nodes and links. The intermediate node may employ few of the seven OSI model layers, which are used to filter or block the unwanted frames of packets. All end nodes have to learn of this new intermediate node and become aware of its existence.

That is to say that Firewalls, according to prior art, utilize a bulky method to remove unsafe data originating from intruders or attackers.

Reference is now made to FIG. 2b which illustrates an exemplary Firewall implementation, according to prior art.

A prior art Firewall 25 implements the OSI seven layers mechanism in order to buffer data sent from a transmitter 21 through a communication link 22, connecting the transmitter 21 to the Firewall 25. The Firewall 25 then processes the data, deletes unwanted data such as the exemplary frame #3-27, and only then re-sends allowed data through a different communication link 26 towards the receiver 24.

In this scheme, the Firewall 25 has to collect, assemble, store, process and then re-transmit all data, as any intermediate node. The Firewall 25 must intervene in the protocols governing the communication link 22, and in the data stream, to do its tasks. With prior art, there is no other way to remove data frames or data packets.

Note that this scheme must use two distinct and separate communication links—22 and 26, connecting the transmitter 21, through the Firewall 25, to the receiver 24.

There is thus a widely recognized need for, and it would be highly advantageous to have an apparatus and method for protection against hostile or unwanted data, transferred on data communication networks, which is devoid of the above limitations.

### SUMMARY OF THE INVENTION

According to one aspect of the present invention there is provided an apparatus for non-intrusive protection against unwanted data segments, transmitted through a data communication link, the apparatus comprising: a detector, configured for detecting a data segment in the data communication link, and an invalidator, associated with the detector, configured for invalidating the data segment upon the data segment being deemed unwanted.

Preferably, the detecting and the invalidating are not interfering with data segment flow through the communication link.

The detecting may include partial extraction of the data segment, without waiting for the whole data segment to traverse the communication link. Optionally, the detecting may be carried out on a bit-by-bit basis, a byte-by-byte basis, a word-by-word basis.

Typically, the invalidating includes inserting a detectable error into the data segment. Preferably, the injected error is unrecoverable even when a Cyclic Redundancy Check (CRC) or a Checksum associated with the data segment are used. The invalidating may include creating a mismatch between the data segment and a Checksum or a CRC, associated therewith. The invalidating may include disrupting a portion of the data segment itself.

The apparatus may also include a decision logic module associated with the detector and the injector, configured for deciding if the data segment is deemed unwanted. The apparatus may further include a repository of rules, associated with the decision logic module, and the decision logic module may utilize the repository of rules for deciding if the data segment is deemed unwanted.

For deciding if the data segment is deemed unwanted, the apparatus may use a predefined list pertaining to unwanted data segments. Alternatively, the decision regarding deeming the data segment unwanted may be based on a predefined list pertaining to allowed data segments. The lists are preferably implemented using the repository of rules.

According to a second aspect of the present invention there is provided a method for non-intrusive protection against unwanted data segments, transmitted through a data communication link, the method comprising: detecting a data segment in the data communication link, deciding if the data segment is deemed unwanted, and invalidating the data segment upon the data segment being deemed unwanted.

Preferably, the detecting and the invalidating are not interfering with data segment flow through the communication link.

Typically, the invalidating includes inserting a detectable error into the data segment. Preferably, the injected error is unrecoverable even when a Cyclic Redundancy Check (CRC) or a Checksum associated with the data segment are used.

The invalidating may include creating a mismatch between the data segment and a Checksum or a CRC, associated therewith. The invalidating may include disrupting a portion of the data segment itself.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram illustrating the seven layers OSI model;

FIG. 2a illustrates a prior art scenario for deleting or removing frames or packets from a communication link;

FIG. 2b illustrates an exemplary Firewall implementation, according to prior art;

FIG. 3 illustrates frame/packet discarding at a receiver node, according to the OSI 7 layers model;

FIG. 4 is a block diagram of a first apparatus for non-intrusive protection against unwanted data segments, according to a preferred embodiment of the present invention;

FIG. 5 illustrates implementation of a second apparatus for non-intrusive protection against unwanted data segments, according to a preferred embodiment of the present invention;

FIG. 6 is a block diagram of a third apparatus for non-intrusive protection against unwanted data segments, according to a preferred embodiment of the present invention;

FIG. 7 illustrates a Firewall implementation according to a preferred embodiment of the present invention;

FIG. 8 is a block diagram of a CAM (Content Addressable Memory) based apparatus for non-intrusive protection against unwanted data segments, according to a preferred embodiment of the present invention;

FIG. 9a is a block diagram of a Comparator based apparatus for non-intrusive protection against unwanted data segments, according to a preferred embodiment of the present invention;

FIG. 9b is a block diagram of a Hardware Rule Comparator based apparatus for non-intrusive protection against unwanted data segments, according to a preferred embodiment of the present invention;

FIG. 10 is block diagram of a RAM based apparatus for non-intrusive protection against unwanted data segments, according to a preferred embodiment of the present invention;

FIG. 11 is a flow chart illustrating a method for non-intrusive protection against unwanted data segments, according to a preferred embodiment of the present invention;

FIG. 12 is a flow chart illustrating a detailed positive logic example of a method for non-intrusive protection against unwanted data segments, according to a preferred embodiment of the present invention;

FIG. 13 is a flow chart illustrating a detailed negative logic example of a method for non-intrusive protection against unwanted data segments, according to a preferred embodiment of the present invention; and

FIG. 14 illustrates a typical Ethernet data frame.

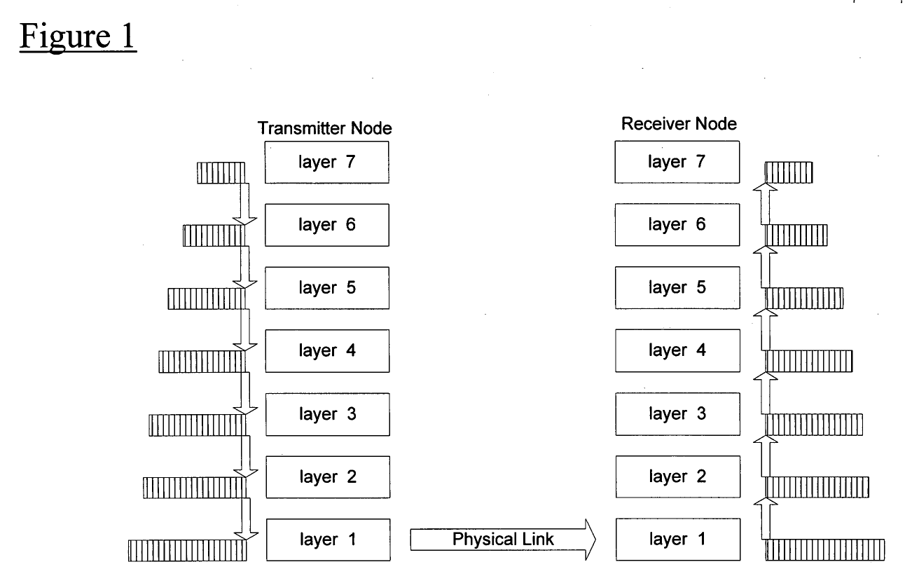

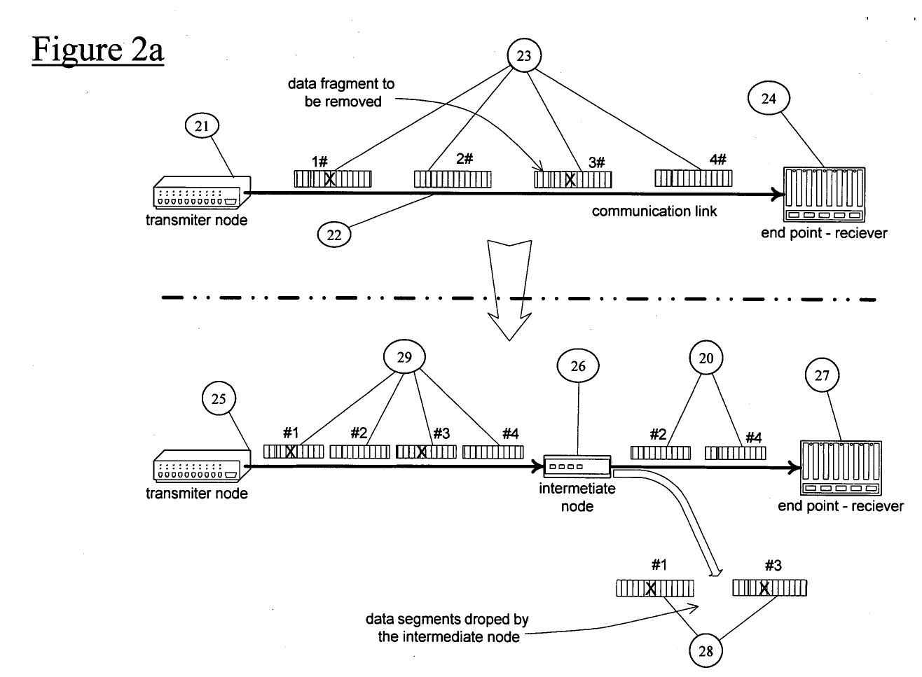

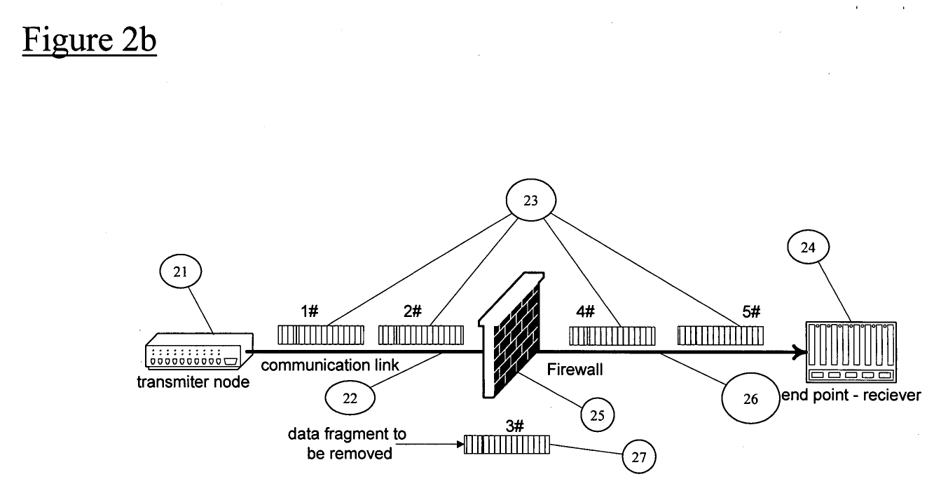

### DESCRIPTION OF THE PREFERRED EMBODIMENTS

The present embodiments comprise an apparatus and a method for non-intrusive protection against unwanted data segments transmitted through a data communication link.

The principles and operation of an apparatus and a method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

A preferred embodiment according to the present invention offers a novel and inventive apparatus and method for protection against unwanted data frames/packets on a communication link connecting two communication nodes.

A preferred embodiment of the present invention relies on the known in the art error control mechanism used by Layer Two or Layer Three of the OSI seven layers communication model in order to disqualify and permanently delete data frames/packets (data segments) which are deemed unwanted.

In data communication networks, an error is a situation in which the received data segment does not match the sent data segments. Errors are a natural part of any data communications network. They can occur at any time and in any location within the communication media between two nodes. There are many reasons for the occurrence of errors in communication networks.

In known in the art data communication networks, each and every receiver node employs an error detection mechanism. This error detection mechanism is an integral part of the implementation of the OSI seven layers model. The mechanism is common to every communication node, and is a prior art mechanism. The mechanism is executed by the OSI Layer Two or OSI Layer Three (usually implemented on the physical line interface card) within the computer dominating that node. This mechanism discards any frame or packet which contains an error of any sort. The erroneous frame or packet is discarded, no matter what was the source or type of the error, and further processing of these frame or packets stops. These discarded frames or packets are lost forever.

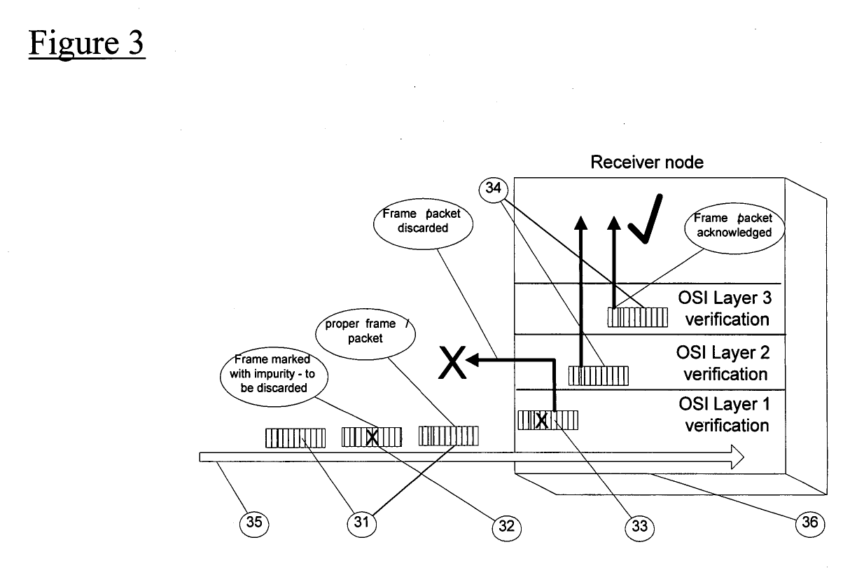

Reference is now made to FIG. 3 which illustrates frame/packet discarding at a receiver node, according to OSI 7 layers model.

An allowed frame/packet (data segment) 31 traverses the communication link 35 alongside an unwanted frame/packet (data segment) which contains an error or an impurity 32. At the receiver node 36, the erroneous frame/packet (data segment) is discarded 33 as it is tested by the communication layers implemented in the receiver node, according to the known in the art OSI 7 layers model implementation. The allowed or error free frame/packet 34 is passed by the communication layers on the receiver node to the upper layers and is validly processed by the application at the receiver node.

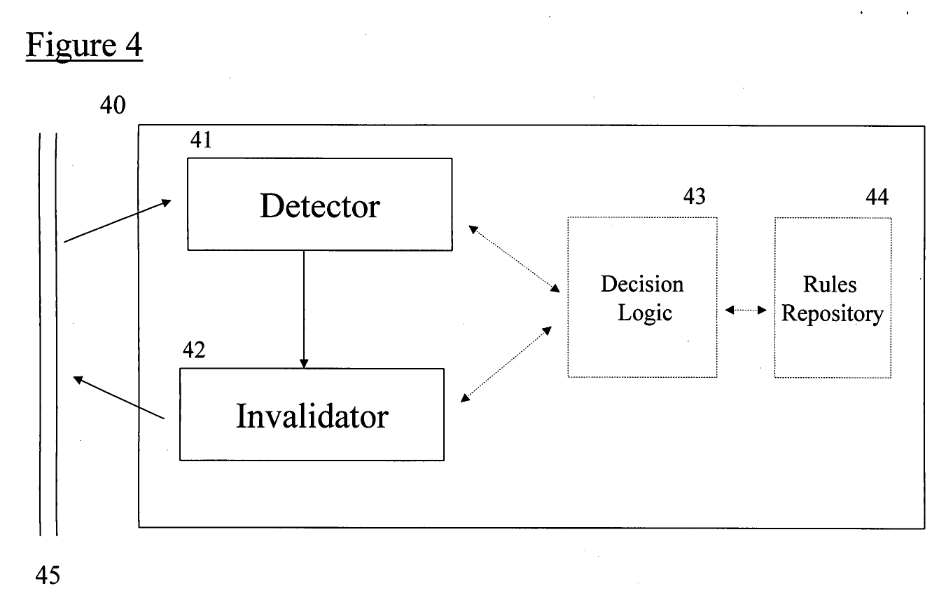

Reference is now made to FIG. 4, which is a block diagram of a first apparatus for non-intrusive protection against unwanted data segments, according to a preferred embodiment of the present invention.

The apparatus 40 comprises a detector 41. The detector 41 is used to detect data frames flowing through a communication link 45. The detector 41 is associated with an invalidator 42 which is configured to invalidate the detected data segment upon the data segment being deemed unwanted. Preferably, the apparatus further includes a decision logic module 43. The decision logic module 43 is associated with the detector 41 and the invalidator 42, and configured for deciding if the detected data segment is an unwanted one.

Preferably, the decision logic module 43 is also associated with a repository of rules 44. The repository of rules 44 may be utilized by the decision logic module 43 for deciding if the detected data segment is unwanted.

An embodiment of the present invention provides a new apparatus for protection against a hostile or any other unwanted frame or packet and prevents it from reaching the destination application, by invalidating it, thus destining it for removal from the communication chain. The apparatus of the present embodiment is preferably non-intrusive to the communication link. The apparatus may be positioned or deployed in any randomly selected point on the physical communication link, which connects the two communication nodes.

That is to say, unlike a prior art Firewall, an apparatus 40 according to a preferred embodiment of the present invention marks the packet/frame by invalidating the packet/frame, without terminating, interfering or blocking the flow of the packet/frame towards a recipient. The regular or normal operation of the receiving application at the recipient then rejects the packet/frame.

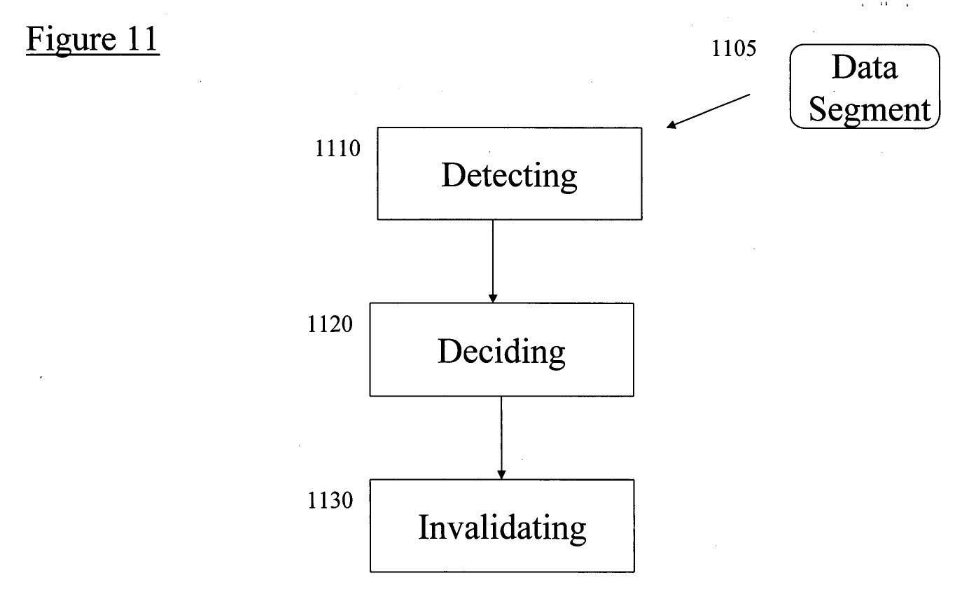

A general description of methods implemented by an apparatus according to a preferred embodiment of the present invention is described herein below and illustrated by flow charts in FIGS. 11, 12 and 13 here in below.

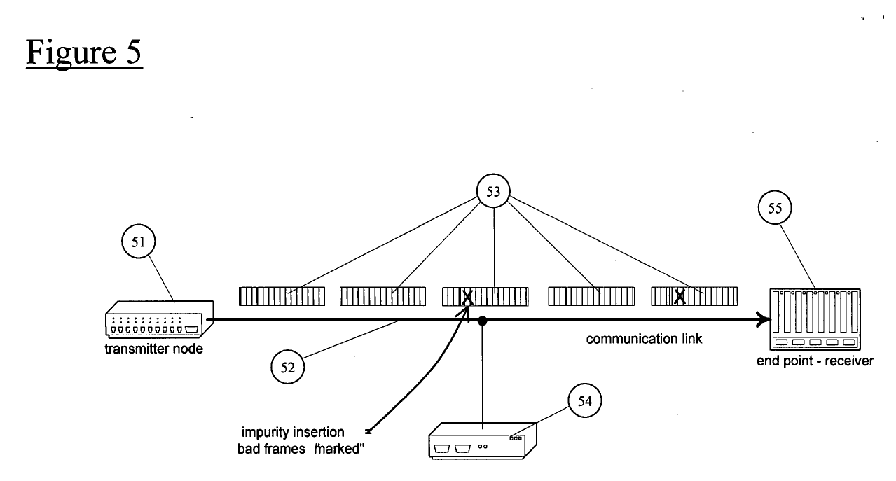

Reference is now made to FIG. 5 which illustrates implementation of a second apparatus for non-intrusive protection against unwanted data segments, according to a preferred embodiment of the present invention.

A transmitter node 51 sends various frames or packets 53 to a destination receiver 55. The physical link 52 conveys these frames or packets from the transmitter 51 to the receiver 55. The apparatus, according to a preferred embodiment, is deployed in a box or a container 54. The apparatus in the box/container allows all packets/frames to flow on to their respective recipients but intercepts and invalidates unwanted packets/frames. The unwanted packets/frames, invalidated by the apparatus, are rejected by regularly operated application(s) at a recipient node.

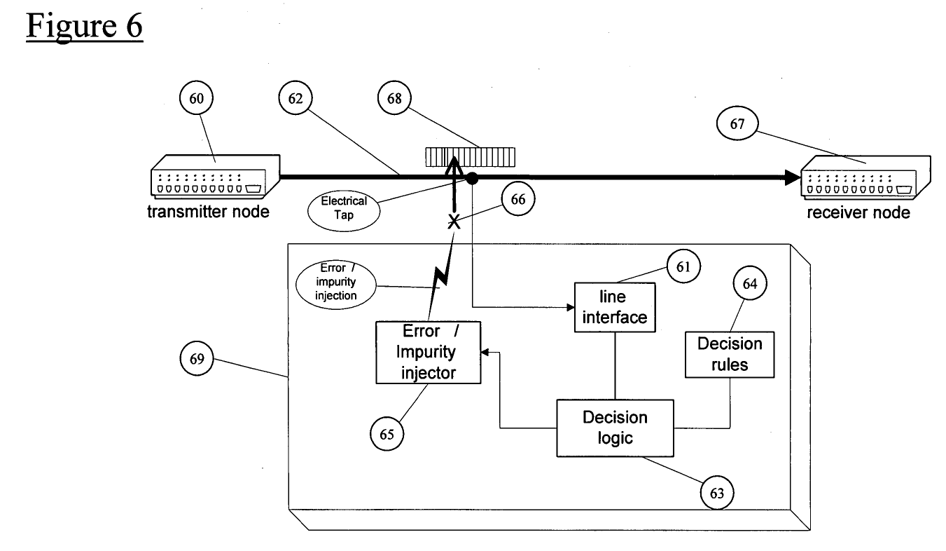

Reference is now made to FIG. 6 which is a block diagram of a third apparatus for non-intrusive protection against unwanted data segments, according to a preferred embodiment of the present invention.

The apparatus 69 includes a line interface detector 61, to decode the current frame or packet 68 which traverses the physical link 62.

The current frame or packet 68 is then compared, by a decision logic module 63 to a repository of rules 64 which may contain a list of the structures (or partial structures) or contents (or a parts of content) of hostile or an unwanted frames/packets.

The decision logic module 63 verifies and checks if the current frame or packet 68 is within the boundary of the disallowed or unwanted frame or packet list, as may be described by the decision rules repository 64.

If a positive identification or correlation exists, the decision logic module 63 decides that the data frame or packet is deemed unwanted.

Upon the verdict of the decision logic module 63 to deem the frame/packet unwanted, an invalidator—such as an error or impurity injector device 65 invalidates the data frame or packet by injecting an error or an impurity 66 into the current data frame or packet. The apparatus according to a preferred embodiment is implemented in a separate box 69, using any electrical network interface.

A preferred embodiment of the present invention, does not have to utilize the entire protocol stack required of a legitimate communication node, as is required by known in the art Firewall systems, and does not have to utilize all prior art required buffers, storage and forwarding mechanisms used in any communication node.

The benefits of an apparatus or a method according to a preferred embodiment of the present invention are three fold: simplifying the design of Firewalls, reducing their costs, and improving their performance. The same holds true for many other security systems such as IDS/IPS systems, mentioned hereinabove.

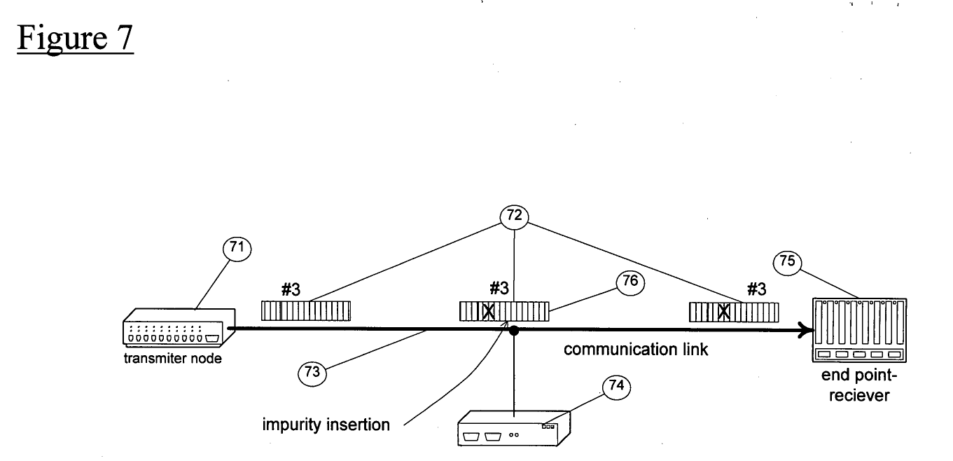

Reference is made to FIG. 7 which illustrates a Firewall implementation according to a preferred embodiment of the present invention.

A transmitter node 71 sends a data frame/packet 72 directly to a receiver node 75 through a communication link 73.

A Firewall unit 74 identifies an unwanted or hostile frame/packet 76, by monitoring the communication link 73. The unit 74, designed according to a preferred embodiment of the present invention, inserts/injects an error or an impurity or few errors/impurities into the unwanted frame/packet, 76.

For clarification, this frame/packet 76 is not discarded at this stage but continues to traverse the link 73 until the frame/packet 76 reaches the receiver node 75. At the receiver node 75, the specific unwanted frame or packet is automatically discarded due to the errors it contains, by the OSI 7 layers model error removal mechanism, implemented at the receiver node, as described hereinabove.

That is to say, errors are introduced deliberately to the hostile/unwanted frame/packet, preferably bringing about a removal of the frame/packet by the OSI error removal mechanism, as described hereinabove.

The following are further detailed descriptions of apparatus according to a preferred embodiment of the present invention.

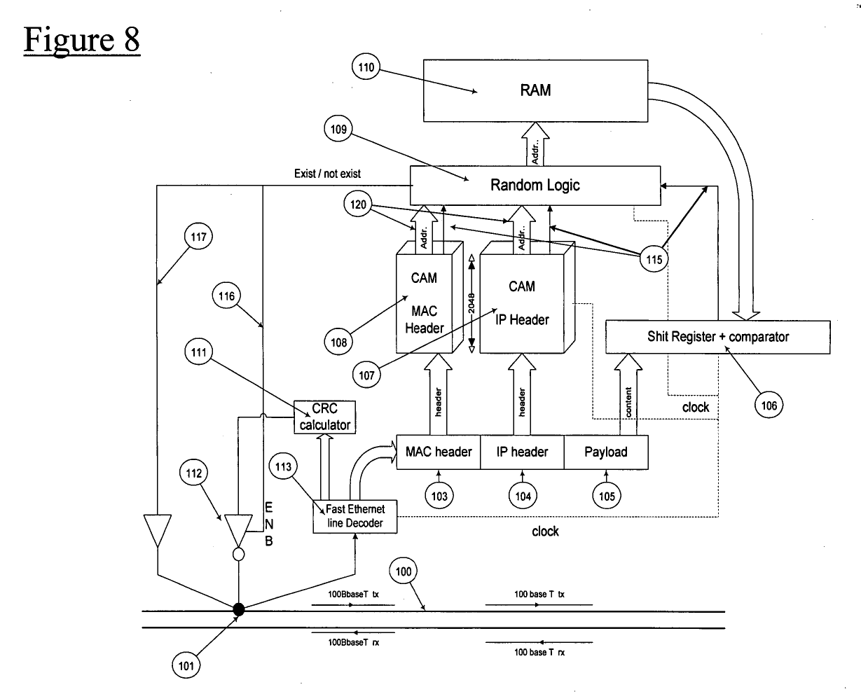

Reference is now made to FIG. 8 which is a block diagram of a CAM based apparatus for non-intrusive protection against unwanted data segments, according to a preferred embodiment of the present invention.

A communication link 100—a 100 Base T fast Ethernet link, or any other communication link, is monitored in an electrical monitoring point 101 on the link. A detector is implemented in an electric monitoring point 101 in order to tap the electrical signals on the communication link 100.

The electric monitoring point 101 is designed with high impedance in order to avoid distorting electrical signals on the communication link 100.

The signals from the link 100 are inserted to a 100 Base T line decoder 113. The line decoder 113 is responsible for converting the electrical analog signals from the link to digital signals comprising bits—representing logical 0s and 1s. This output bit stream represents the current time frame or packet traversing the communication link 100. The bits are loaded from the line decoder 113 into the storage registers 103-105 as soon as they become available from the communication link 100.

The output bits, streamed form the line decoder 113, are parsed to a MAC header, IP header, and Payload, according to an Ethernet frame structure, as defined by known in the art Ethernet standards, and inserted to the registers 103-105.

Each information element is located in a different register: the MAC header 103, the IP header 104, and the frame/packet payload 105.

The MAC header is sent into a Content Address Memory (CAM) device 108 which stores a list of the MAC headers belonging to unwanted or hostile frames. This list is generally referred to as rules, in the language of security experts. These rules represent a part of a decision rules repository.

The CAM 108 searches for a correlation between its input—the MAC header 103 of the current frame/packet and the entire rules stored within its memory. The CAM 108 does so within one, single clock cycle, or few clock cycles. If a positive correlation exists—meaning there is a match between the input MAC header and one of the rules stored within the CAM 108 than the CAM sends a signal 115 to the Random Logic unit 109.

According to a preferred embodiment, the signal 115 indicates that the existing frame contains a MAC header which correlates with one of listed unwanted or hostile frames/packets.

The IP header is processed in the exact same logic as the MAC header is, but through a parallel path. The IP header extracted from the current frame/packet is stored within a shift register 104.

The IP header is sent to a CAM 107 which contains rules pertaining to unwanted or hostile IP headers. These rules are stored within the memory of the CAM. As in the case of the MAC header, when a positive correlation is found, a signal 115 is sent to the Random Logic unit 109, indicating that the existing frame bears a correlation with one of listed unwanted or hostile frames/packets.

Optionally, if a correlation exists, both CAMs may also send a location descriptor or an address of the rule which produced the positive correlation 120. This location descriptor/address is then sent to a Random Access Memory (RAM) 110 which may store instructions for further processing of the frame/packet. For example, the RAM 110 may store instructions for searching for a pattern within the payload of the frame/packet (data segment).

If further search is needed within the current frame/packet payload, a data pattern, stored within the RAM 110, is sent for searching to a Shift Register/Comparator 106. The Shift Register also holds the payload of the current frame or packet 105, extracted from the line decoder 113. The Shift Register/Comparator 106 shifts the search pattern received from the RAM 110 over the entire payload, and if a positive correlation is found, a signal 115 is sent to the Random Logic 109.

If the Random Logic 109 receives a positive correlation signal 115 from any of the CAMs 107-108 or from the Shift Register/Comparator 106, than this means that the current frame/packet is unwanted and should be rejected.

According to a preferred embodiment of the present invention, invalidating the unwanted frame/packet may be carried out in any of the following ways:

(1) Disrupting the Cyclic Redundancy Check (CRC) by inversion—The needed CRC is calculated using the CRC calculator 111. The output of the CRC calculator 111 is then inverted by a logical inverter 112. However, the inverter 112 is normally in a disabled state, meaning that its output is at high impedance state not affecting the communication link 100. When the Random Logic 109 decides to invalidate the current frame/packet (data segment), preferably bringing about a removal of the data segment, it sends an ENABLE signal 116 to the inverter 112, enabling its output. When the inverter is enabled, its signal disrupts the communication link 100. The output of the inverter 112 is an inverted version of the CRC which collides with the normal CRC present on the communication link 100. This causes the CRC of the frame/packet to be disrupted, invalidating the whole frame or packet, preferably bringing about a rejection of the frame/packet (data segment) by known in the art mechanisms such as the OSI error removal mechanism, implemented at the receiver node, as described hereinabove.

(2) Disrupting the Cyclic Redundancy Check (CRC) by injecting a signal—Disrupting the CRC may also be done by injecting an electrical signal 117 (optionally comprised of random values) to the communication link 100 during the time period of the CRC. This signal 117 disrupts the CRC value, thus invalidating the whole frame or packet.

(3) Disrupting the frame/packet itself—Upon discovery of an unwanted or hostile frame/packet as indicated by the correlation signal 115, the Random Logic 109 sends a long enough signal equal to a logical 0 state or a logical 1 state at any place within the body of the frame/packet without waiting for the CRC to arrive.

Disrupting the body of the frame or packet causes a data discrepancy between the entire frame/packet (data segment) data and the CRC associated there with, thus invalidating the entire data segment and preferably bringing about a removal of the data segment by known in the art mechanisms such as the OSI error removal mechanism, implemented at the receiver node, as described hereinabove.

According a preferred embodiment of the present invention, a Comparator Array is used.

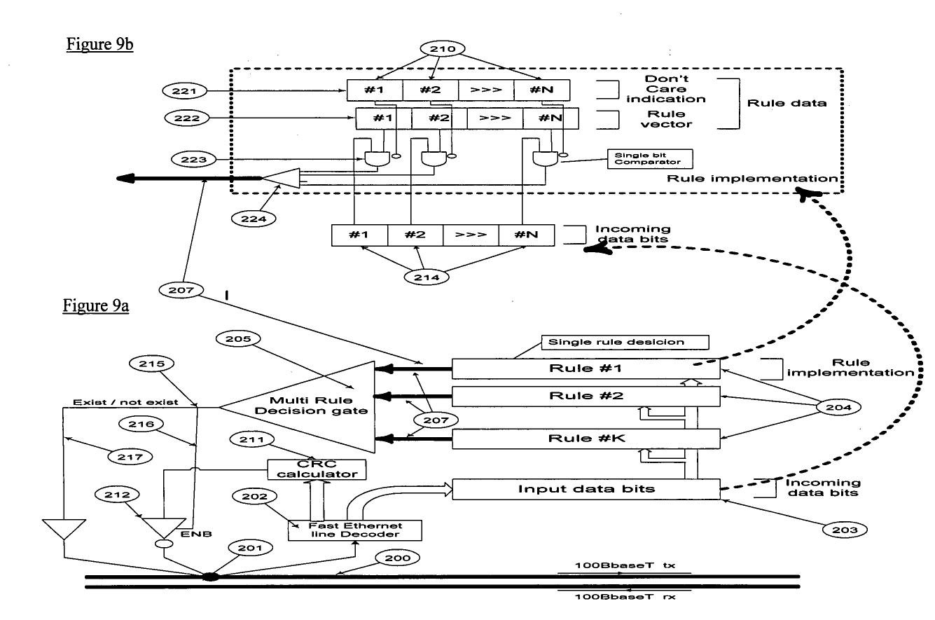

Reference is now made to FIG. 9a which is a block diagram of a Comparator based apparatus for non-intrusive protection against unwanted data segments, according to a preferred embodiment of the present invention.

A communication link 200—a 100 Base T fast Ethernet link, or any other communication link, is monitored in an electrical monitoring point 201 on the link 200. A detector is implemented in an electric monitoring point 201 in order to tap the electrical signals on the communication link 200.

The electric monitoring point 201 is designed with high impedance in order to avoid distorting electrical signals on the communication link 200.

The signals from the link 200 are inserted to a 100 Base T line decoder 202.

A line decoder 202 is responsible to convert the electrical analog signals from the link 200 to digital signals comprising bits representing logical 0s and 1s. This output bit stream represents the current time frame or packet traversing the communication link 200. Portions of the frame/packet which are extracted from the link 200 are loaded into the storage register 203 as soon as they become available from the communication link 200, for comparison.

The current frame/packet, stored in the data register 203, is compared to a set of decision rules 204, implemented in hardware. The rules are an exemplary part of a decision rules repository, as described hereinabove.

Each of these decision rules 204 sends a correlation signal 207 which indicates if a match is found between the stored frame/packet 203 and a decisions rule 204. The entire set of correlations signals 207, are then inserted into a large Multi Rule Decision Gate 205 which performs a logical OR between the entire set of correlation signals 207. If one or more of the correlation signals 207 has a value of “TRUE” (meaning that a positive correlation to one or more rule exists), than the output signal 215 of the Multi Rule Decision Gate 205 is set to TRUE. This indicates that the current frame or packet is deemed unwanted and should to be removed.

According to a preferred embodiment of the present invention, invalidating the unwanted frame/packet may be carried out in any of the following ways:

(1) Disrupting the Cyclic Redundancy Check (CRC) by inversion—The needed CRC is calculated using the CRC calculator 211. The output of the CRC calculator 211 is then inverted by a logical inverter 212. The inverter 212 is normally in a disabled state, meaning that its output is at high impedance state, not affecting the communication link 200. When the Multi Rule Decision Gate 205 decides to remove the current frame/packet, the Multi Rule Decision Gate 205 sends an ENABLE signal 216 to the inverter 212, thus enabling the output of the inverter 212. When the inverter 212 is enabled, its signal disrupts the communication link 200. The output of the inverter 212 is an inverted version of the CRC which collides with the original normal CRC present on the communication link 200. Consequently, the CRC of the frame/packet (data segment) is disrupted, thus invalidating the whole data segment and preferably bringing about a removal of the data segment by known in the art mechanisms such as the OSI error removal mechanism, implemented at the receiver node, as described hereinabove.

(2) Disrupting the Cyclic Redundancy Check (CRC) by injecting a signal—Disrupting the CRC may also be done by injecting an electrical signal 217, possibly with random values, to the communication link 200 during the time period of the CRC. This signal 217 disrupts the CRC value, thus invalidating the whole frame or packet (data segment), and preferably bringing about a removal of the data segment by known in the art mechanisms such as the OSI error removal mechanism, implemented at the receiver node, as described hereinabove.

(3) Disrupting the frame/packet itself—Upon discovery of an unwanted or hostile frame/packet, as indicated by any of the correlation signals 207, the Multi Rule Decision Gate 205 sends a long enough signal 215 equal to a logical 0 state or a logical 1 state at any place within the body of the frame/packet (data segment) without waiting for the CRC to arrive. Disrupting the body of the data segment creates a data discrepancy between the entire frame/packet (data segment) data and the CRC associated there with. This inconsistency invalidates the entire data segment, preferably bringing about a removal of the data segment, for example, by a known in the art error removal mechanism, as described hereinabove.

According a preferred embodiment of the present invention, a Hardware Rule Comparator is used.

Reference is now made to FIG. 9b which is a block diagram of a Hardware Rule Comparator based apparatus for non-intrusive protection against unwanted data segments, according to a preferred embodiment of the present invention.

According to a preferred embodiment of the present invention, a hardware rule implementation may be based on a configuration where all hardware rules are composed of two vectors.

The first vector 222 contains the actual value of the decision rule. The second vector is a Don't Care indication vector 221 which contains an indication for rule bits which are marked as Don't Care.

A logical combination of these bit vectors is then compared, bit by bit, simultaneously, by an array of single bit comparators 223 with the data bits of the frame/packet 214. The data bits 214 are actually the bits that are stored in input bits 203, extracted from the line decoder 202. The single bit comparators 223 produce a TRUE output if the compared bits are identical and if the Don't Care bit is set to FALSE. All the single bit comparators 223 are connected in a large logic gate 224 which produces an output 207. The output 207 is TRUE only if ALL comparators are TRUE.

A preferred embodiment of the present invention is based on a Rapid Access Memory (RAM) Rule implementation.

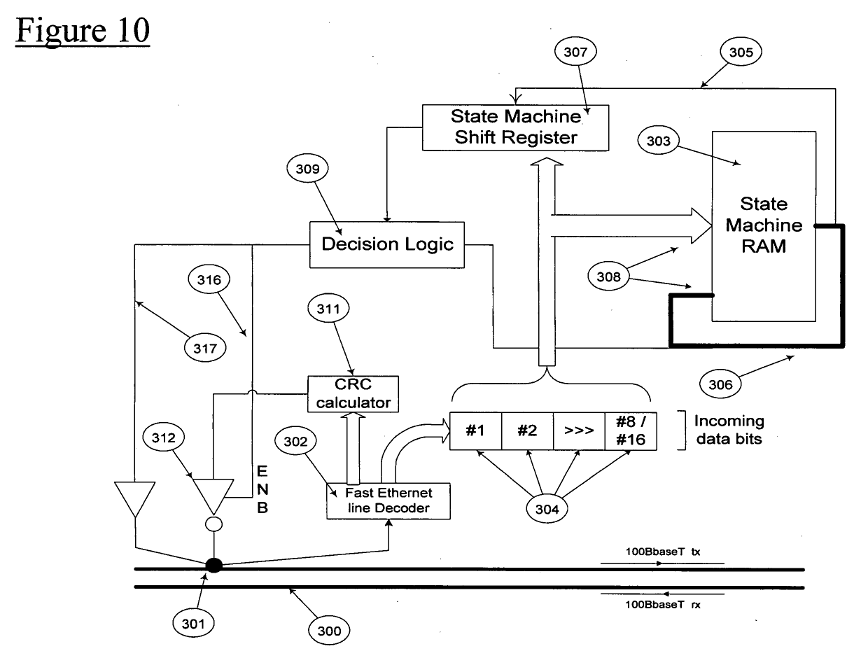

Reference is now made to FIG. 10 which is block diagram of a RAM based apparatus for non-intrusive protection against unwanted data segments, according to a preferred embodiment of the present invention.

A RAM 303, as described in this example, acts as an implementation of a STATE MACHINE which describes the set of decision rules.

The entire set of decision rules is pre-processed and translated to a set of codes which are in turn loaded into the RAM 303.

Within the RAM 303, a code search and comparison is conducted, based on byte-by-byte (or word-by-word) composition of the frame/packet. The search progresses until all the current frame/packet bytes or words are accounted for and a match is found, or until a No-Match code is reached.

The content of the RAM 303 holds the set of instruction representing the decision rules (pre-processed per each chunk of eight or sixteen bits) per each rule.

For every eight/sixteen bits of the current frame/packet the RAM 303 accesses an instruction written in the address location which corresponds to the value of the eight or sixteen bits information structure of the current frame or packet.

This specific instruction contains the information whether the current byte or word is a part of any decision rule or not, along with the instruction for the next step.

The process continues until a match is found. If a match is found the process stops and a Match verdict is generated. If no match is found the process terminates with a No-Match verdict. Based the resultant Match/No-Match verdict, the frame/packet may be deemed unwanted and preferably destined for removal, for example—by a known in the art mechanism such as the OSI error removal mechanism, implemented at the receiver node, as described hereinabove.

In a given example, a communication link 300—a 100 Base T fast Ethernet link, or any other communication link, is monitored in an electrical monitoring point 301 on the link 300. A detector is implemented at an electric monitoring point 301 in order to tap the electrical signals on the communication link 300.

The electric monitoring point 301 is designed with high impedance in order to avoid distorting electrical signals on the communication link 300.

In this example, the signals from the link 300 are inserted to a 100 Base T line decoder 302. The line decoder 302 is responsible for converting the electrical analog signals from the link 300 to digital signals bits representing logical 0s and 1s. This output bit stream represents the current frame/packet traversing the communication link 300.

The frame/packet, represented as the output bit stream from the line decoder 302, is then loaded to an eight or sixteen bits (byte/word) storage register 304, for comparison.

These bytes or words are loaded from the line decoder 302 into the storage register 304 as soon as they become available from the communication link 300. In each cycle of the rule search, the storage register 304 takes these bytes or words and loads them into the RAM 303, as part of the RAM's address ports 308.

As described hereinabove, the RAM 303 performs the search for a possible correlation in the decision rules stored within the RAM 303. The search progresses as more and more bytes or words are loaded from the communication link 300 into the storage register 304, and then into the RAM 303.

Optionally, in addition to the RAM 303, the current frame or packet is loaded into a shift register 307. Outputs from the RAM 303 are also loaded into the shift register 307. The shift register 307 then performs a parallel bit-by-bit shifted search with the current frame/packet and the information received from the RAM 303.

Search results from both the RAM 303 and the shift register 307 are then loaded into the decision logic 309 for a final verdict. The final verdict signals 316, 317 are set to TRUE when the current frame/packet is deemed unwanted and needs to be removed.

According to a preferred embodiment of the present invention, invalidating the unwanted frame/packet may be carried out in any of the following ways:

(1) Disrupting the Cyclic Redundancy Check (CRC) by inversion—The needed CRC is calculated using the CRC calculator 311. The output of the CRC calculator 311 is then inverted by a logical inverter 312. The inverter 312 is normally in a disabled state, meaning that its output is at high impedance state, not affecting the communication link 300.

When the Decision Logic 309 decides to invalidate the current frame/packet, upon finding it unwanted, the Decision Logic 309 sends an ENABLE signal 316 to the inverter 312, enabling the output of the inverter 312. When the inverter 312 is enabled, the signal of the inverter 312 disrupts the communication link 300. The output signal of the inverter 312 is an inverted version of the original CRC which collides with the original normal CRC, present on the communication link 300. This causes the CRC of the frame/packet to be disrupted, thus invalidating the whole frame/packet (data segment) and preferably bringing about a removal of the data segment, for example—by a known in the art mechanism such as the OSI error removal mechanism, implemented at the receiver node, as described hereinabove.

(2) Disrupting the Cyclic Redundancy Check (CRC) by injecting a signal—As described hereinabove, disrupting the CRC may also be done by injecting an electrical signal 317, possibly with random values, to the communication link 300 during the time period of the CRC. This signal 317 disrupts the CRC value, thus invalidating the whole frame or packet.

(3) Disrupting the frame/packet itself—Upon discovery of an unwanted or hostile frame/packet, the Decision Logic 309 sends a long enough signal 317 equal to a logical 0 state or a logical 1 state at any place within the body of the frame or packet without waiting for the CRC to arrive. Disrupting the body of the frame/packet (data segment) creates a data discrepancy between the entire data segment and the CRC associated there with. This inconsistency leaves the data segment invalid and preferably brings about a removal of the data segment, for example—by a known in art mechanism such as the OSI error removal mechanism, implemented in a receiver node, as described hereinabove.

Reference is now made to FIG. 11 which is a flow chart illustrating a method for non-intrusive protection against unwanted data segments, according to a preferred embodiment of the present invention.

First, a data segment 1105 is detected 1110. Preferably the detection is carried out on a bit-by-bit, byte-by-byte, or word-by-word basis, such that the data segment may be detected even before the whole data segment is captured. Next comes deciding 1120 if the data segment 1105 is deemed unwanted. If the data segment 1105 is deemed unwanted, it is invalidated 1130, say by injecting an error or an impurity into the data segment 1105, preferably bringing about a removal of the data segment 1105 by an error removal mechanism such as the OSI model error removal mechanism which is implemented in the receiver node, as described hereinabove.

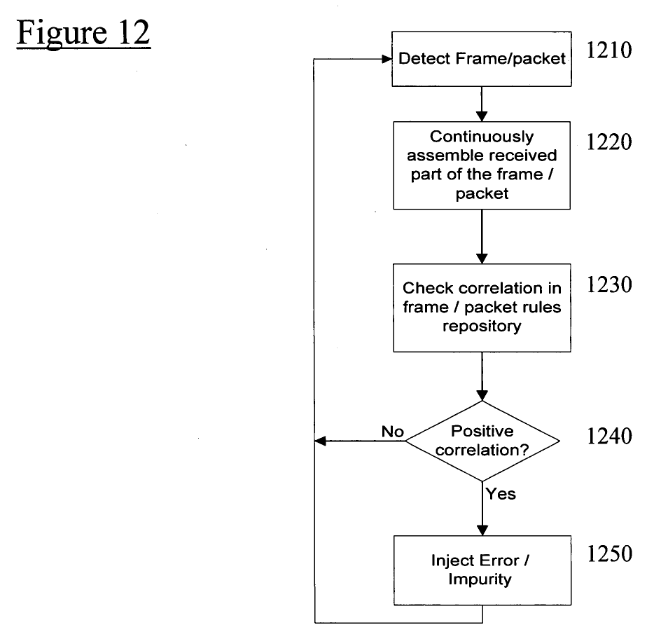

Reference is now made to FIG. 12 which is a flow chart illustrating a detailed positive logic example of a method for non-intrusive protection against unwanted data segments, according to a preferred embodiment of the present invention.

An apparatus according to a preferred embodiment of the present invention, as described hereinabove may implement the following method steps:

First, a data frame/packet (data segment) is detected 1210, say a detector as described hereinabove. The parts of the frame/packed are continuously assembled 1220. A decision is then made regarding the data segment, say by a decision logic module as described hereinabove: the data segment is checked 1230 against a list pertaining to unwanted data frames/packets. Preferably, the list is implemented utilizing a repository of rules, as described hereinabove. If a positive correlation is found between the data segment and the list 1240, the data segment is invalidated, say by injecting 1250 an error or an impurity into the data segment, as described hereinabove, otherwise the data segment is left unharmed.

Alternatively, there is a negative logic embodiment of the present invention.

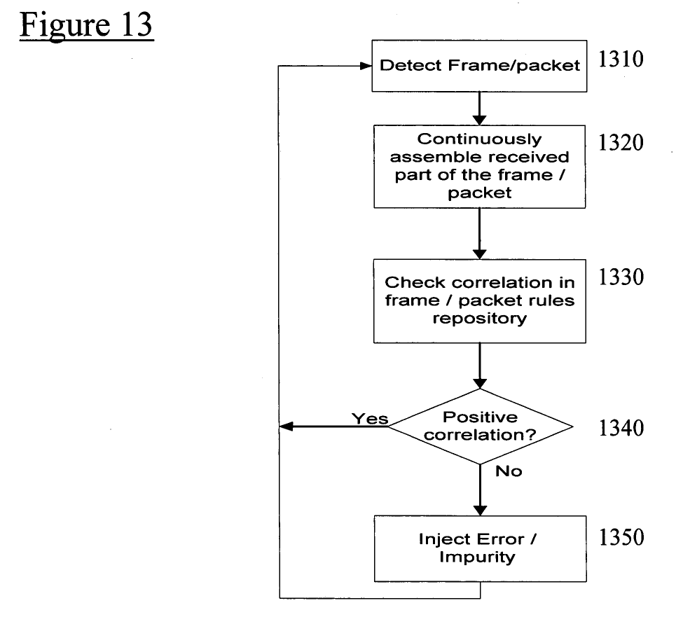

Reference is now made to FIG. 13 which is a flow chart illustrating a more detailed negative logic example of a method for non-intrusive protection against unwanted data segments, according to a preferred embodiment of the present invention.

An apparatus according to a preferred embodiment of the present invention, as described hereinabove may implement the following method steps:

First, a data frame/packet (data segment) is detected 1310, say by a detector as described hereinabove. The parts of the frame/packed are continuously assembled 1320. A decision is then made regarding the data segment, say by a decision logic module as described hereinabove: the data segment is checked 1330 against a list pertaining to allowed data frames/packets. Preferably, the list is implemented utilizing a repository of rules, as described hereinabove. If the decision logic module fails to find a positive correlation 1340 between the data segment and the list, the data segment is invalidated, say by injecting 1350 an error or an impurity into the data segment, as described hereinabove. Otherwise, the data segment is left unharmed.

By invalidating the data segment, as taught here in the above described embodiments, the data segment is destined for removal by an error removal mechanism such as the OSI model error removal mechanism, implemented at a receiver node, as described hereinabove and illustrated in FIG. 3.

Time Analysis

A preferred embodiment of the present invention utilizes ASICS that are designed to work at a clock of 400 Mhz. With this embodiment, comparators are designed using analog comparison methods where no caching of information is needed. These comparators operate at “line speed” hence at 1 Ghz clocks cycles.

The following table shows the relevant timing analysis for preferred embodiments of the present invention as shown above.

TABLE 1
Timing Analysis

| Phase | Clock cycles | time | |
|---|---|---|---|
| Loading the vector into the | 1 clock (400 Mhz) | 2.5 | nS |
| EPLD/RAM/CAM | | | |
| Vector comparison | 2-4 clocks maximum | 5 | nS |
| Output calculation | 1.5 clock | 2.25 | nS |
| CRC disruption | At least 4 Bits | 4 | nS |
| Total | | 13.75 | nS |

Thus an optimal time requirement for completing an invalidating decision, for a preferred embodiment of the present invention is 13.75 ns.

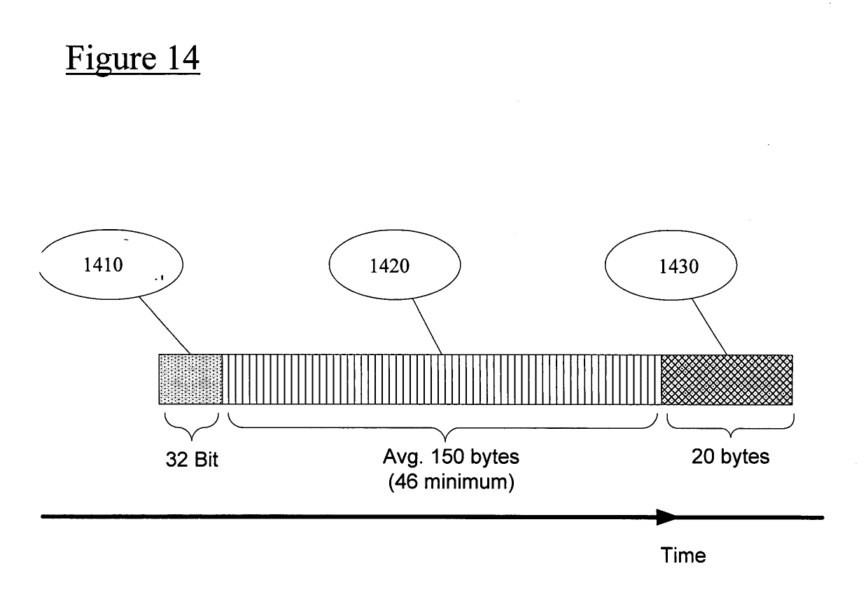

Reference is now made to FIG. 14 which illustrates a typical Ethernet data frame. The typical data frame/packet comprises a 32 bits long CRC/Checksum 1410, an average 150 bytes long payload 1420 and 20 bytes long header 1430.

A one GigaBit (1000 base T) Ethernet link has a fast 1 GHz clock where each bit duration is about 1 ns.

In a preferred embodiment of the present invention, the decision to invalidate a data frame/packet is based on the value of the frame/packet header 1430 only, as illustrated and explained hereinabove. Thus with a 1000 base T Ethernet link, after reading the 20 Bytes long header, the decision has to be made within a 1232 ns period: 150 Bytes×8 bits×1 ns/bit (for the Payload 1420)+32 bits×1 ns/bit (for the CRC/Checksum 1410)=1200+32 ns=1232 ns.

In an embodiment of the present invention a decision whether to invalidate the frame/packet is made according to the entire frame/packet.

In a worse case scenario where this embodiment is used, a frame/packet is the shortest possible. With this worst case scenario, the frame/packet comprises no payload and the time period for the decision is based only on the CRC/Checksum. Consequently the time period is limited to 32 ns: 32 CRC/Checksum bits×1 ns/bit.

As shown and illustrated using a table hereinabove, an optimal time requirement for completing an invalidating decision, for a preferred embodiment of the present invention is 13.75 ns.

Thus even the worst case scenario, limiting the duration for making the decision to 32 ns, is easily handled by a preferred embodiment having a 13.75 ns time requirement as described and illustrated using a table hereinabove

The concepts and process of the invention are applicable to both wired and wireless transmission technologies. For this reason the invention is applicable on both network types.

All logical states of the signals shown here are described in a particular logical state behavior. Each of these signals can be operated in reverse logic without changing any of the functionality or any of the characteristics of the invention.

All decision rules and all decision signals that relate to particular or specific frames or packets which need to be removed from the link apply equally, in reverse logic, to specific frames or data packets that need to remain on the communication link while all other frames or packets need to be removed form the communication link.

Although several embodiments described hereinabove reference an Ethernet link, the embodiments are applicable to all known in the art data link technologies. The technologies include but are not limited to all technologies listed herein below.

For ease of explanation all implementation examples provided here discuss data frames or packets traveling in the same direction. The same examples apply equally to frames and packets traveling to all directions of the communication link—transmit as well as receive. Most of today's networking implementations are full duplex implementations where both transmitted and received frames/packets are present on a single communication link. The discussed implementations fit symmetrically to both communication link directions by simply duplicating the implementation for each direction.

An apparatus or a method according to a preferred embodiment of the present invention is applicable to any available data communication links. Examples may include but are not limited to:

Ethernet technologies: 10 Base-T; 100 Base-T; 1000 Base-T (in many times referred to as Giga Bit Ethernet or GbE)

WAN standard interface links: V.35, V.24, V.21, HDLC, X21, V.11, V.36, V.11, HSSI

E, T, and J series links: E1, E3, T1, T3, J1;

G-703 links, such as: DS1, DS2, DS3, DS4

xDSL links such as: HDSL, ADSL, SHDSL, VDSL, ADSL2, ADSL2+

Optical transmission via Fiber optic links

Modem standards: V.21, V.22 V.22 bis, V.26, V.26bis, V.27 bis, v.29, v.32, v.33, v.42, v.42 bis

HDLC, SDLC

ISDN standards: ISDN-B, ISDN-D, ISDN HO, ISDN H11, ISDN H-12 LAPD, LAPB

WLAN using all its various formats.

Dedicated communication buses such as USB, IEEE1394, Firewire, and SCSI

RS-449/RS-422, RS232, RS530 and other serial links.

V5 protocols

ATM protocols and links

Frame Relay protocols and links

X.25 protocols and links

IP protocols and links

PPP links
Any other LAN or WAN protocol at OSI layer One or OSI layer Two or OSI layer Three, used over any data-communication link.

It is expected that during the life of this patent many relevant data communication devices and systems will be developed and the scope of the terms herein, particularly of the terms ““Data segment”, “Data packet”, “Data frame”, “Communication link”, “Detector”, “Decision Logic Module”, “Invalidator”, and “Injector”, is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for non-intrusive protection against unwanted data segments, transmitted through a data communication link to a recipient, the apparatus comprising:
a detector, configured for detecting a data segment in the data communication link; and
an invalidator, associated with the detector, configured for invalidating the data segment upon the data segment being deemed unwanted, the apparatus being configured to allow the invalidated data segment to continue through said data link after invalidation, said invalidating allowing said data segment to be identified and rejected at said recipient.

2. The apparatus of claim 1, wherein said invalidating brings about a rejection of the data segment

3. The apparatus of claim 1, wherein said invalidating brings about a rejection of the data segment by an Open Systems Interconnection (OSI) model error removal mechanism implemented at a node, said node receiving the data segment.

4. The apparatus of claim 1, wherein said invalidating includes inserting a detectable error into the data segment.

5. The apparatus of claim 4, wherein said error is an unrecoverable error.

6. The apparatus of claim 1, further comprising a decision logic module, associated with the detector and the injector, configured for deciding if the data segment is deemed unwanted.

7. The apparatus of claim 6, further comprising a repository of rules, associated with the decision logic module, wherein the decision logic module utilizes the repository of rules for said deciding if the data segment is deemed unwanted.

8. The apparatus of claim 1, wherein said invalidating further comprises low communication layer disruption of the data segment.

9. The apparatus of claim 1, wherein said invalidating further comprises creating a mismatch between the data segment and a Cyclic Redundancy Check (CRC) associated therewith.

10. The apparatus of claim 1, wherein said invalidating further comprises creating a mismatch between the data segment and a Checksum associated therewith.

11. The apparatus of claim 1, wherein said invalidating further comprises disrupting the CRC associated with the data segment.

12. The apparatus of claim 1, wherein said invalidating further comprises disrupting the Checksum associated with the data segment.

13. The apparatus of claim 1, wherein said invalidating further comprises disrupting a portion of the data segment.

14. The apparatus of claim 6, wherein said deciding is carried out according to a predefined list pertaining to unwanted data segments.

15. The apparatus of claim 6, wherein said deciding is carried out according to a predefined list pertaining to wanted data segments.

16. The apparatus of claim 1, wherein said detector is further configured for decoding the data segment.

17. The apparatus of claim 1, wherein said detecting further comprises partially extracting the data segment.

18. The apparatus of claim 17, wherein said extracting is done on one of a group comprised of a bit-by-bit basis, a byte-by-byte basis, and a word-by-word basis, thereby facilitating detection of an unwanted data segment before extracting the entire data segment.

19. Method for non-intrusive protection against unwanted data segments, transmitted through a data communication link to a recipient, the method comprising:
detecting a data segment in the data communication link;
deciding if the data segment is deemed unwanted;
invalidating the data segment upon the data segment being deemed unwanted; and
allowing the invalidated data segment to continue through said data communication link, said invalidating being such as to allow for rejection of said invalidated data segment at said recipient.

20. The method of claim 19, wherein said invalidating brings about a rejection of the data segment.

21. The method of claim 19, wherein said invalidating includes inserting a detectable error into the data segment.

22. The method of claim 21, wherein said error is an unrecoverable error.

23. The method of claim 19, wherein said invalidating further comprises low communication layer disruption of the data segment.

24. The method of claim 19, wherein said invalidating further comprises creating a mismatch between the data segment and a Cyclic Redundancy Check (CRC) associated therewith.

25. The method of claim 19, wherein said invalidating further comprises creating a mismatch between the data segment and a Checksum associated therewith.

26. The method of claim 19, wherein said invalidating further comprises disrupting the CRC associated with the data segment.

27. The method of claim 19, wherein said invalidating further comprises disrupting the Checksum associated with the data segment.

28. The method of claim 19, wherein said invalidating further comprises disrupting a portion of the data segment.

29. The method of claim 19, wherein said deciding is carried out according to a predefined list pertaining to unwanted data segments.

30. The method of claim 19, wherein said deciding is carried out according to a predefined list pertaining to wanted data segments.

31. The method of claim 19, further comprising, after detecting the data segment, decoding the data segment.

32. The method of claim 19, wherein said detecting further comprises partially extracting the data segment.

33. The method of claim 32, wherein said extracting is done on one of a group comprised of a bit-by-bit basis, a byte-by-byte basis, and a word-by-word basis, thereby to facilitate detection of an unwanted data segment before extracting the entire data segment.
